(19) United States
(12) Patent Application Publication
(10) Pub. No.: US 2014/0036220 A1
(43) Pub. Date: Feb. 6, 2014

(54) Personal Security Eyeglasses

(71) Applicant: Nnamdi Jerry Ashiogwu, Adelphi, MD (US)

(72) Inventor: Nnamdi Jerry Ashiogwu, Adelphi, MD (US)

(21) Appl. No.: 13/803,196

(22) Filed: Mar. 14, 2013

Related U.S. Application Data
(60) Provisional application No. 61/678,654, filed on Aug. 2, 2012.

(51) Int. Cl. G02C 7/14

(52) U.S. Cl. CPC G02C 7/14
USPC 351/50

(57) ABSTRACT

Personal security glasses for a wearer comprising a frame and lens assembly, and at least one reflective member, wherein the reflective member is capable of showing reflection of the wearer's surroundings. The invention allows the wearer to have better ability to observe his surroundings, especially, areas adjacent or behind him, artificially increasing his field of view without the wearer having to turn or pivot his head of body. The personal security glasses can be made of prescription lenses, sunglasses and can incorporate night vision technologies to allow the wearer to observe his surroundings even in low light condition.

### CROSS-REFERENCE TO RELATED APPLICATIONS

The present application claims the benefit of U.S. Provisional Application No. 61/678,654 filed on Aug. 2, 2012, which is hereby incorporated by reference.

### FIELD OF INVENTION

The present invention is related to eyeglasses, more specifically eyeglasses to enhance personal security through increased aware of the wearer's surroundings.

### BACKGROUND OF THE INVENTION

Personal accessories, such as eyeglasses, are known. They can serve purposes from increasing fashion to shielding the wearer's eyes from hash sunbeams. When they are worn, they can improve the wearer's eyesight and clarity of objects with the wearer's field of view. However, current eyeglasses do not help to increase the peripheral vision of the wearer, and thus does not increase the wearer's field of view. In order to see the surrounding immediately adjacent or behind him, the wearer must physically turn his head or pivot his body so that such areas come within his field of vision.

Accordingly, it is the object of this invention to provide an improved personal security eyeglasses to overcome drawbacks and inadequacies of known eyeglasses.

### SUMMARY OF THE INVENTIONS

Personal security glasses for a wearer comprising a frame and lens assembly, and at least one reflective member, wherein the reflective member is capable of showing reflection of the wearer's surroundings. Personal security device for a wearer comprising a frame and lens assembly having a frame and two lens elements, said frame having a central axis perpendicular to the wearer's face and the two lens elements, each positioned and attached to the frame on the two sides of the central axis of the frame; at least one reflective member; wherein the at least one reflective member is attached to the frame and lens assembly and the wearer's can observe the surrounding behind him through images reflected in the reflective member. Personal security device for a wearer comprising a frame and lens assembly having a frame and two lens elements, said frame having a central axis perpendicular to the wearer's face and the two lens elements, each positioned and attached to the frame on the two sides of the central axis of the frame; at least one reflective member; a mechanism for attaching the at least one reflective member to the frame and lens assembly, wherein the at least one reflective member increases the wearer's overall field of vision through providing reflections of the wearer's surrounding, allowing the wearer to observe the surrounding behind him through images reflected in the reflective member.

A more complete appreciation of the present invention and its scope can be obtained from the following description of the drawings, detailed description of presently preferred embodiments of the invention, and the appended claims.

### BRIEF DESCRIPTION OF THE DRAWINGS

For a fuller understanding of the invention, reference is made to the following description taken in connection with the accompanying drawings, in which:

FIG. 1 is a front view of a personal security eyeglasses in accordance with an embodiment of the present invention;

FIG. 2 is a front view of an embodiment of the present invention illustrating a protruding profile created by the reflective member;

FIG. 3 is a front view of an embodiment of the present invention illustrating the reflective member integrated into the contour line of the frame and lens assembly;

FIG. 4 is a front view of an embodiment of the present invention illustrating an example the reflective member's position;

FIG. 5 is a front view of an embodiment of the present invention illustrating an example the reflective member's position;

FIG. 6 is a front view of an embodiment of the present invention illustrating an example the reflective member being in built-into the lens element.

FIG. 7 is a front view of an embodiment of the present invention illustrating an exemplary shape and location of the reflective member.

FIG. 8 is a front view of an embodiment of the present invention illustrating an exemplary shape and location of the reflective member.

FIG. 9 is a front view of an embodiment of the present invention illustrating an exemplary shape and location of the reflective member.

FIG. 10 is a front view of an embodiment of the present invention illustrating an exemplary shape and location of the reflective member.

FIG. 11 is a front view of an embodiment of the present invention illustrating an exemplary shape and location of the reflective member.

FIG. 12 is a front view of an embodiment of the present invention illustrating an exemplary shape and location of the reflective member.

FIG. 13 is a front view of an embodiment of the present invention illustrating an exemplary shape and location of the reflective member.

FIG. 14 is a front view of an embodiment of the present invention illustrating an exemplary shape and location of the reflective member.

### DETAILED DESCRIPTION OF THE PREFERRED EMBODIMENTS

Certain exemplary embodiments of the present invention will now be described with reference to the drawings. In general, such embodiments relate to a personal security eyeglasses. It is to be understood that any size, shape or construction of the personal security eyeglasses are all within the scope of the invention. Still other objects and advantages of the invention will in part be obvious and will in part be apparent from the specification.

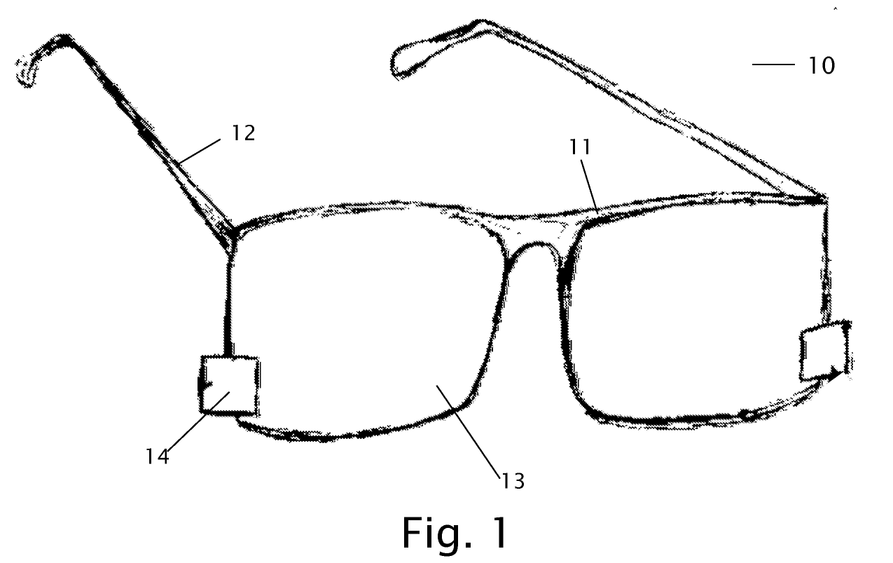

In accordance with the present invention, personal security eyeglasses are shown in FIGS. 1 -6. Personal security eyeglasses include a frame and lens assembly 10 and at least one reflective member 14.

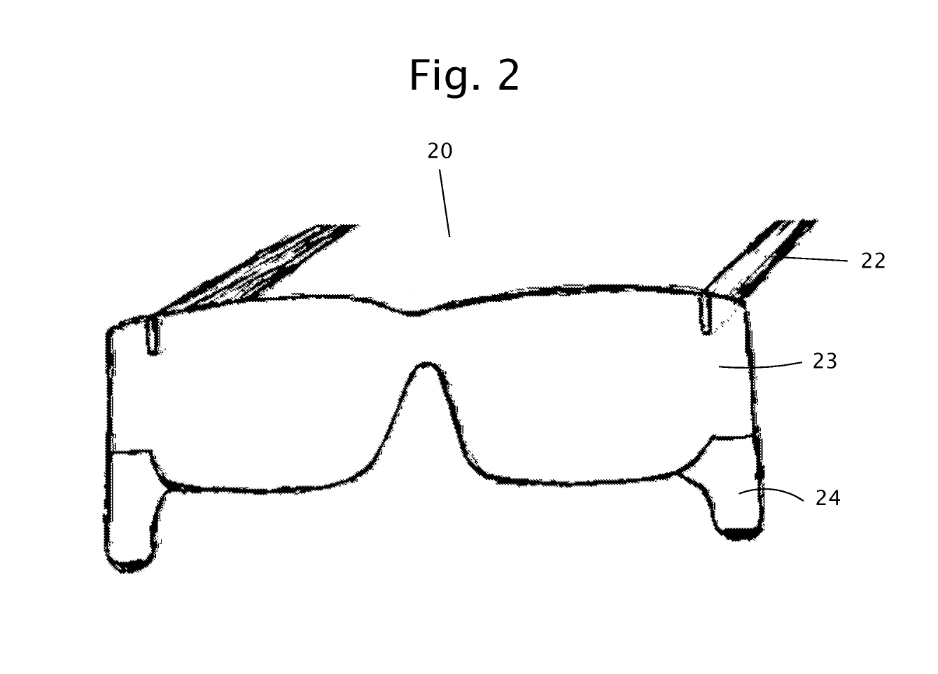

The frame and lens assembly 10 can include a frame 11, temples 12 and at least one lens element 13. The frame can provide structure and stability to the frame and lens assembly. The lens element 13 can shield the wearer's eyes from eternal elements or conditions such as sunray, glare, or dust particles. The lens element 13 can be made from prescription glasses to improve a wearer's vision. They can also be clear, tinted or be made from darkened glasses or plastic and serve as sunglasses. Each frame and lens assembly 10 can include at least one lens element 13, FIG. 1, or a single elongated lens element 23, as shown in FIG. 2. The temples 12 can be used to rest the whole assembly on the wearer's ears and to position the eyeglasses in front of the wearer's eyes.

The frame and lens assembly 10 can take many shapes or configuration and be made from various materials known in the art. For example, in FIG. 1, the temples 12 can be hingedly attached to the frame 11 from the posterior while the lens elements 13 are attached to the frame 11 from the anterior to form the frame and lens assembly 10. In another configuration, as illustrated in FIG. 2, the temples 22 are hingedly attached directly to the lens element 23 to form the frame and lens assembly 20. In addition, the frame and lens assembly 10 can be generally contoured shaped to provide better fit to the wearer. The frame and lens assembly 10 can further include a centrally positioned bridge piece. The bridge piece ideally rests on the wearer's nose comfortably. The bridge piece can help position the glass assembly as well and provide comfort to the wearer.

Furthermore, the lens element 13 can be attached to the frame 11 using known mechanical and chemical fasteners, such as glue or small screws. Alternatively, the frame 11 can be constructed to securely receive and hold the lens elements 13 without the use of a fastener.

In accordance to the invention, the personal security glasses further comprise at least one reflective member 14. The reflective member 14 can serve as a mechanism for the wearer to see his surroundings through reflections, thus increase his peripheral vision. The ability to “see” beyond the wearer's normal field of vision, especially areas immediately adjacent and behind the wearer can give the wearer an increased awareness of his safety and surroundings. The increased field of vision and awareness of his surroundings, is not gained at the expense of the wearer's normal field of view, since the wearer does not have to move his body or head in order to observe what is going on adjacent and behind him.

The reflective member 14 can be made from various materials or achieved through various methods, including direct coating on lens element 13, or applying a film to create a reflective surface. In one embodiment the reflective member can further include night vision technologies, to allow the wearer to observe his surroundings even when the light condition is not optimal. The reflective member also can be built into the anterior side of the lens element 13, and thus is invisible to people facing the wearer.

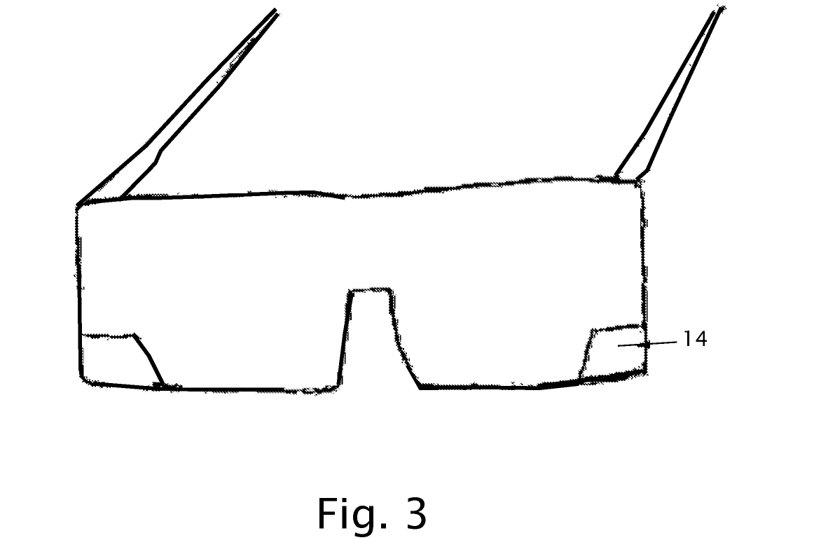

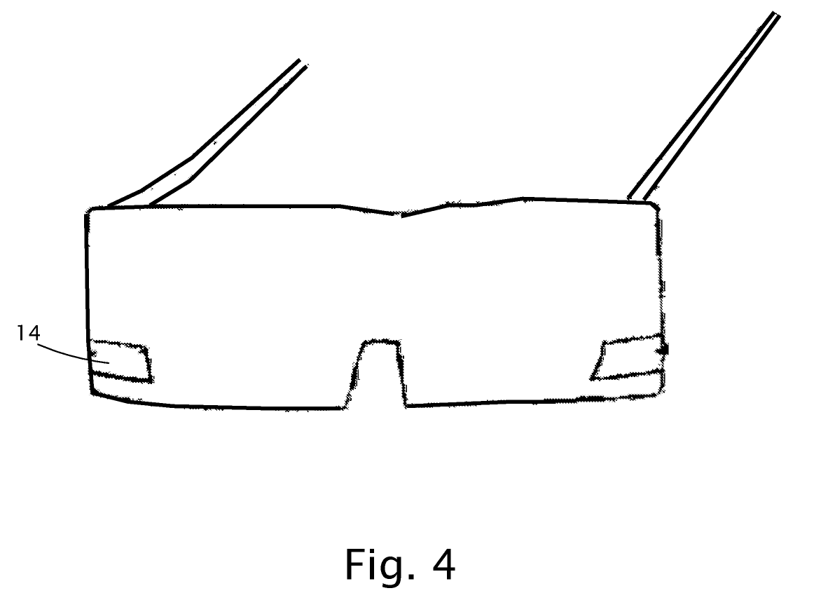

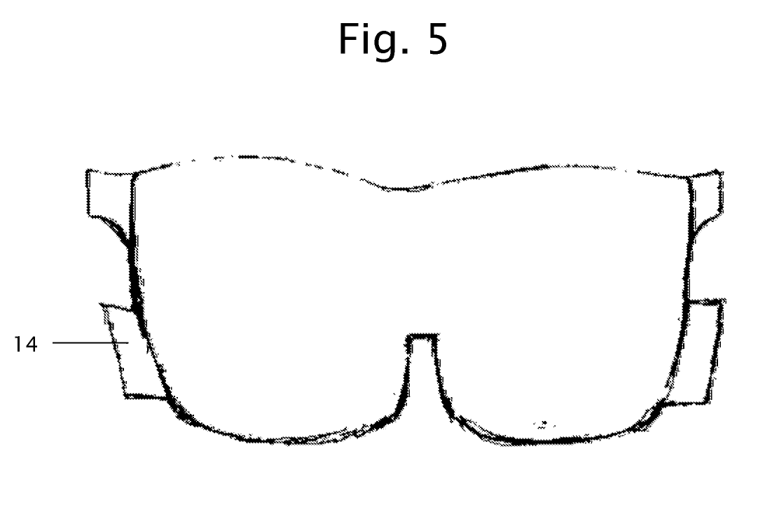

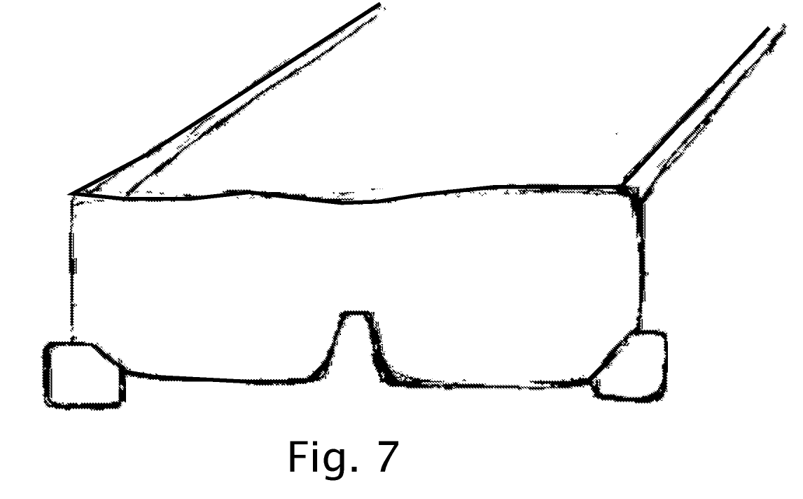

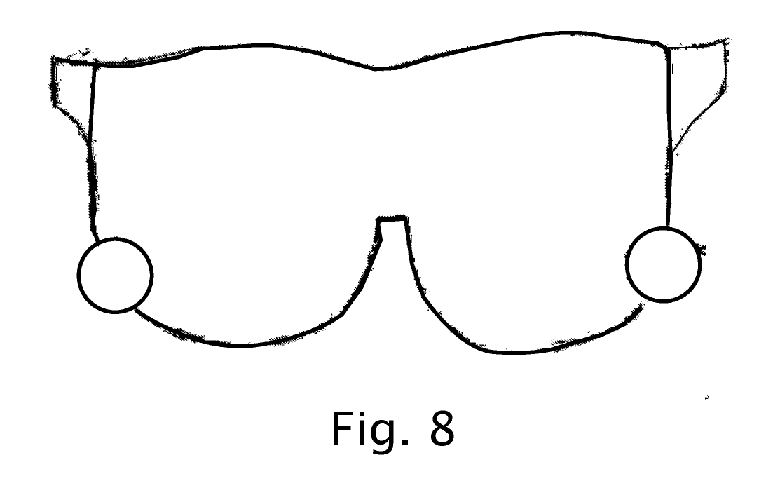

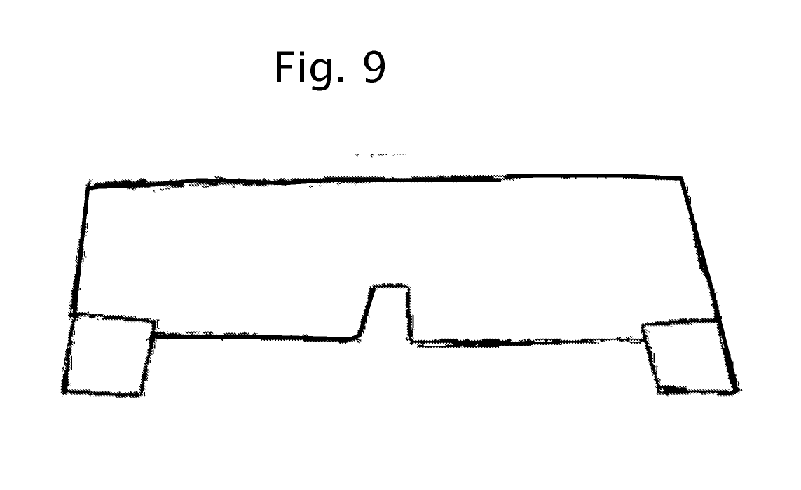

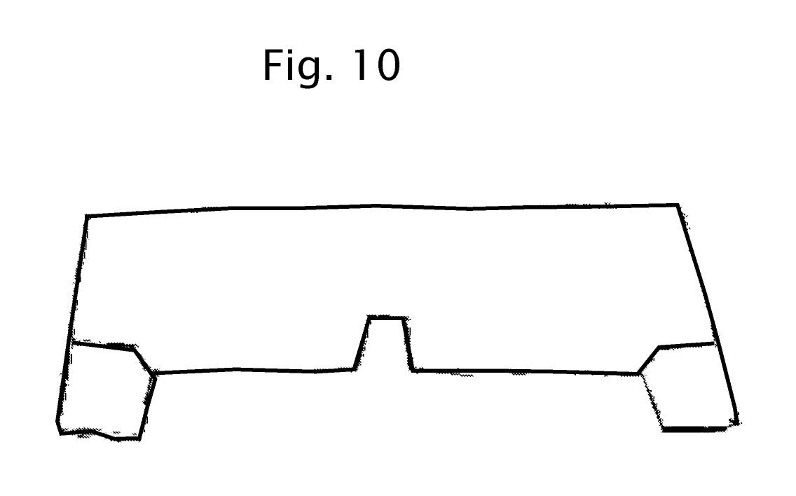

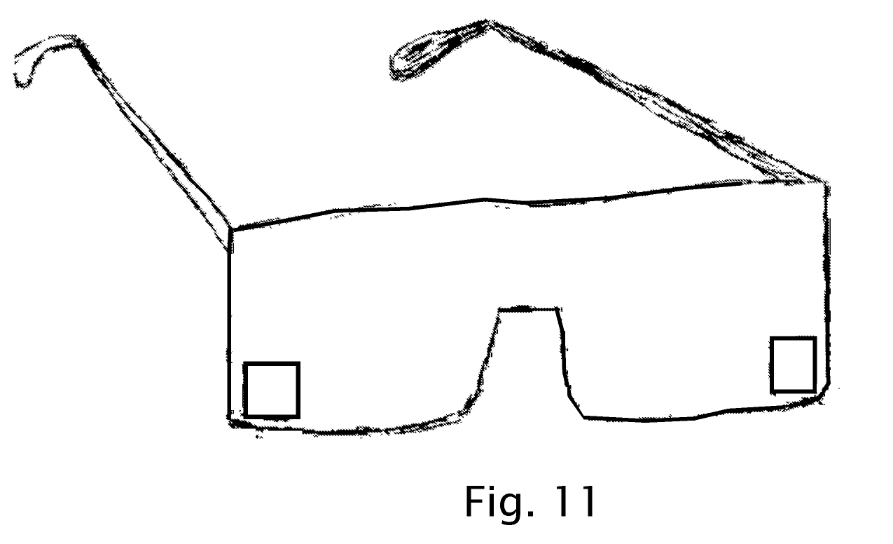

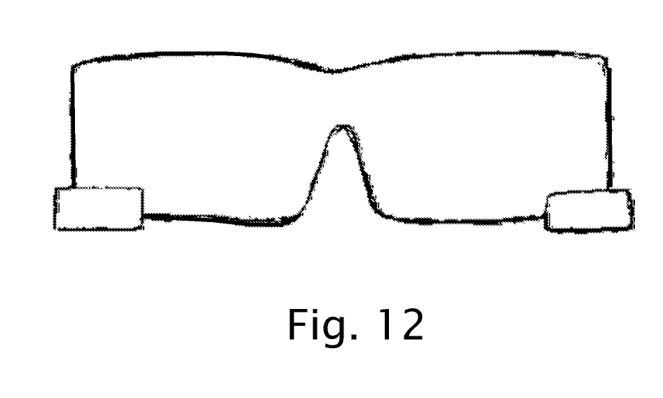

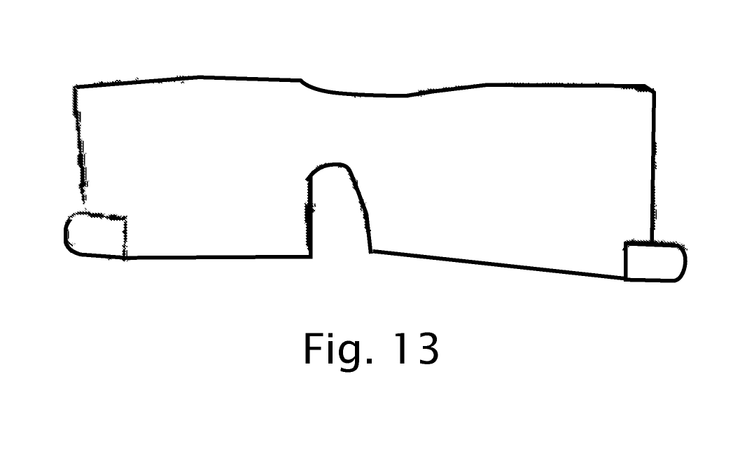

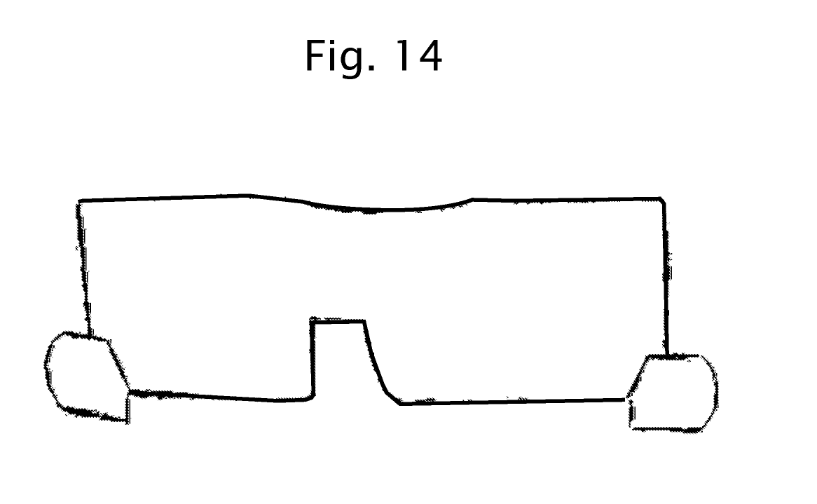

It is to be understood that the reflective member 14 does not need to be in any specific size or shape, so long as the size or the shape can provide the wearer with an increased peripheral vision through seeing reflections of his surroundings. As shown in FIGS. 1-14, the reflective member can include rectangular, circular or angular shapes. In one embodiment, as shown in FIG. 2, the reflective member 24 is affixed to the frame and lens assembly, but does not follow the general contour lines of the assembly, instead, it introduces a protruding profile. In accordance of the invention, the size and shape of the protruding profile can depend on the size of the assembly to provide optimal viewing angle and area for the wearer. See FIG. 5. In comparison, FIGS. 3 and 4 show embodiments of the invention where the reflective member 14 is integrated to the general contour line of the frame and lens assembly and does not create a protrusion in the outline of the frame and lens assembly.

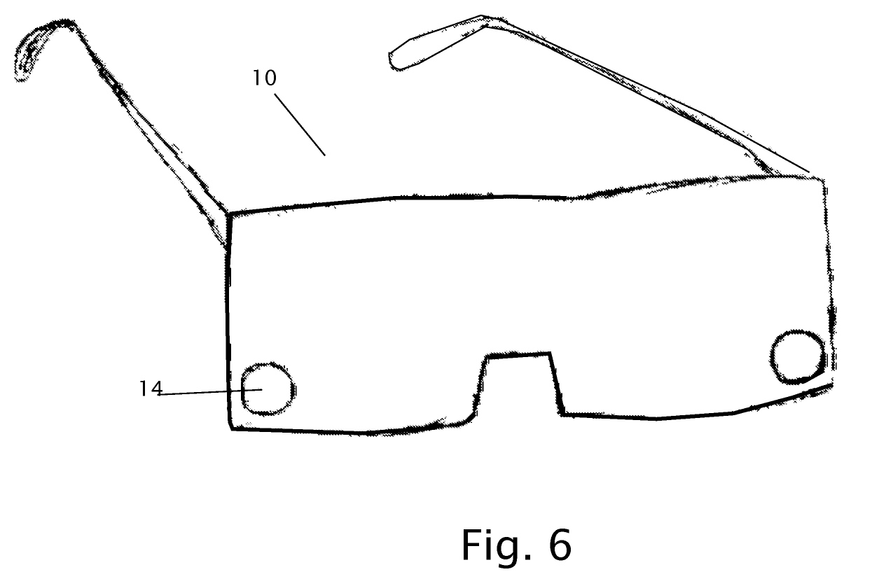

The reflective member 14 can be removably attached to the frame and lens assembly or permanently affixed to it through various means. In one embodiment of the invention, one or more reflective member 14 is permanently inserted and seamlessly incorporated into the frame and lens assembly 10, thus cannot be easily removed. See FIG. 6. In another embodiment, the reflective members 14 are removably attached or mounted to the frame and lens assembly. In accordance to this embodiment of the invention, the reflective members 14 can be removed without damaging the function or the look of the frame and lens assembly. This removable configuration allows wearer to select and switch to the specific size and shape of the reflective member 14 according to his preference.

Furthermore, the reflective member 14 can be attached to the frame and lens assembly 10 at a predetermined opening slot, completing the contour outline of the frame and lens assembly 10. Alternative, the reflective member 14 can be mounted on the frame and lens assembly 10 not at any predetermined location.

In yet another embodiment of the invention, the reflective member 14 comprises of a portion of the lens element 13 having reflective properties to provide the wearer with a reflected image of his surroundings. Reflective member 14 can be positioned near or at the outer edge of the frame and lens assembly. However, it is understood that the reflective member can be positioned anywhere, depending on the shape and size of the frame and lens assembly, as long as there is clearance to allow the reflective member to show reflections of the surrounding behind and/or around the wearer. Furthermore, reflective member 14 can additional include properties that would increase the wearer's observation. In one embodiment, the reflective member 14 can be made from magnifying mirror.

The examples provided are merely exemplary, additional alterations can be made, as a way of non-limiting example, the length, width, thickness or shape of the lens elements, frame, temples or reflective members may vary as a matter of application specific to design choice, and should not be construed to limit the scope of the invention in any way. Thus, while there have been shown, described and pointed out novel features of the present invention as applied to preferred embodiments thereof, it will be understood that various omissions and substitutions and changes in the form and details of the disclosed invention may be made by those skilled in the art without departing from the spirit of the invention.

It is also to be understood that the following claims are intended to cover all of the generic and specific features of the invention herein described and all statements of the scope of the invention which, as a matter of language, might be said to fall therebetween.

What is claimed is:

1. Personal security glasses for a wearer comprising:
a frame and lens assembly;
and at least one reflective member,
wherein the reflective member is capable of showing reflection of the wearer's surroundings.

2. The personal security glasses of claim 1, wherein the frame and lens assembly further comprising a frame, two lenses and two temples.

3. The personal security glasses of claim 2, wherein the lenses are made of prescription lenses.

4. The personal security glasses of claim 2, wherein the lenses are colored or tinted.

5. The personal security glasses of claim 1, wherein the at least one reflective member is made of a mirror.

6. The personal security glasses of claim 2, wherein the at least one reflective member is a portion of the lenses.

7. The personal security glasses of claim 1, wherein the reflective member is removably attached to the lens and frame assembly.

8. The personal security glasses of claim 1, wherein the reflective member is permanently attached to the lens and frame assembly.

9. The personal security glasses of claim 1, wherein the reflective member is positioned on the edge of the lens and frame assembly.

10. The personal security glasses of claim 1, wherein the reflective member is rectangular, oval or circular.

11. The personal security glasses of claim 1, wherein the reflective member is attached to the frame and lens assembly at a predetermined position.

12. The personal security glasses of claim 1, wherein the reflective member further comprising night vision technologies to enhance the wearer's ability to see in low light conditions.

13. The personal security glasses of claim 1, wherein the reflective member is invisible to people other than the wearer.

14. Personal security device for a wearer comprising:
a frame and lens assembly having a frame and two lens elements, said frame having a central axis perpendicular to the wearer's face and the two lens elements, each positioned and attached to the frame on the two sides of the central axis of the frame;
at least one reflective member,
wherein the at least one reflective member is attached to the frame and lens assembly and the wearer's can observe the surrounding behind him through images reflected in the reflective member.

15. The personal security device of claim 14, wherein the at least one reflective member is a mirror.

16. The personal security device of claim 14, where in the at least one reflective member is achieved through a coating on at least one of the two lens elements.

17. The personal security device of claim 14, wherein the reflective member is mechanically attached to the frame and lens assembly.

18. The personal security device of claim 14, wherein the reflective member is chemically bonded to the frame and lens assembly.

19. Personal security device for a wearer comprising:
a frame and lens assembly having a frame and two lens elements, said frame having a central axis perpendicular to the wearer's face and the two lens elements, each positioned and attached to the frame on the two sides of the central axis of the frame;
at least one reflective member;
a mechanism for attaching the at least one reflective member to the frame and lens assembly;
wherein the at least one reflective member increases the wearer's overall field of vision through reflections, allowing the wearer to observe the surrounding behind him through images reflected in the reflective member.

20. The personal security device of claim 14, wherein the at least one reflective member is a mirror or is a reflective coating on at least one of the two lens elements.
